(19) United States
(12) Patent Application Publication
(10) Pub. No.: US 2009/0321471 A1
(43) Pub. Date: Dec. 31, 2009

(54) AUTONOMOUS ANNOUCEMENT SYSTEM FOR MECHANICAL VENDING MACHINES

(76) Inventor: Aniceto Pedro Alcaraz Garcia, Murcia (ES)

Correspondence Address: MERCHANT & GOULD PC, P.O. BOX 2903, MINNEAPOLIS, MN, 55402-0903, US

(21) Appl. No.: 12/301,575

(22) PCT Filed: Apr. 13, 2007
(86) PCT No.: PCT/ES07/00220

§ 371 Date: Sep. 9, 2009

(30) Foreign Application Priority Data
May 19, 2006 (ES) P200601301

(51) Int. Cl. G07F 11/00

(52) U.S. Cl. 221/9

(57) ABSTRACT

Autonomous claim system, for mechanical vending machines, of the type that dispense products when the correct coin in inserted into a coin slot and a handle for activating the machine is rotated, which places in motion a gear mechanism for activating the machine. The system comprises an electronic control board (1) powered by a battery (2), each board (1) having at least one microcontroller (3) and sound-synthesizing means (4); means (8) for detecting rotation of the gear mechanism for activating the machine, which are connected to the microcontroller (3) inlets; light means (7) controlled by the microcontroller (3); and at least one loudspeaker (6) connected to the sound-synthesizing means (4). When the means (8) for detecting rotation of the gear mechanism detect a movement of the latter, the microcontroller (3) activates the light means (7) and sound-synthesizing means (4) for a preset period, thereby attracting the attention of the public.

### FIELD OF THE INVENTION

The present invention relates to an announcement system for mechanical vending machines which work without an electrical connection, of the type serving plastic round or oval shaped balls with toys therein or other products, such as chewing gum and dried fruits and nuts, incorporating in the latter an announcement based on the use of lights and sound to attract the attention of users.

### BACKGROUND OF THE INVENTION

Mechanical vending machines (without an electrical connection) used for the sale of toys inside plastic balls, chewing gum, dried fruits and nuts and the like, are machines the operating systems of which are exclusively limited to providing by means of a mechanical action the sale of a product directly or by interacting with it before dispensing it. These are all machines which only have the attraction of the machine itself or the product within the machine

There are usually two types of mechanical vending machines: interactive and not interactive. In the first case the user can interact with the ball or the product before it is dispensed, adding entertainment to the sale of the product. Normally these are pinball type machines with side pivots operated by respective buttons or other means in order to be able to hit the ball or the product before being dispensed and being able to be withdrawn from the tray arranged in the machine for its collection. In the second case the user is limited to inserting the coin and rotating a handle, the ball or the product dispensed falling into a tray arranged in the machine to be collected.

With the present invention, the aim is to increase its attractiveness for the public by increasing the interest in them, adding a system that can be adapted to already existing and future machines, whereby the attraction of the customer for whom they are intended increases, incorporating sound and light effects and including the possibility of interacting with them. The present invention consists of installing an autonomous electronic system formed by a system for detecting when the machine starts working which starts up the same and controls a system of lights and sound, as well as a system for detecting light using a light sensor such that when it gets dark, it activates, without needing to dispense any product, part of the light system of the machine, increasing the attractiveness and cost-effectiveness of the machine

### DESCRIPTION OF THE INVENTION

The invention relates to an announcement system for mechanical vending machines according to claim 1. Preferred embodiments of the system are defined in the dependent claims.

The announcement system is applied for mechanical vending machines of the type that dispense products when the correct coin is introduced in a coin slot and a handle for activating the machine is rotated, which places in motion a gear mechanism for activating the machine.

The system consists at lease on electrical control board powered by at least one battery, each electronic boarding having at least one microcontroller with analog and/or digital inputs and outputs and sound-synthesizing means. The system further incorporates means for detecting the rotation of the handle of the gear mechanism for activating the machine, connected to at least one microcontroller, a plurality of light means controlled by the at least one microcontroller; and at least one loudspeaker connected to the sound-synthesizing means. The means for detecting the rotation of the gear mechanism for activating the machine could be for example a micro-push buttons located close to the gear mechanism and which is activated by the movement of one of the teeth of the gear mechanism. The light means can be high-luminescence LEDs for example.

The system works such that when the means for detecting the rotation of the gear mechanism detect a movement thereof, the at least one microcontroller activates the light means and sound-synthesizing means according to a preestablished time, normally saved in an internal memory of the microcontroller.

To save battery power, the microcontroller remains in a minimum consumption state, in the so-called sleep mode, except during the time in which it activates the light means and sound-synthesizing means. The autonomy of the system is thus increased. To increase the autonomy of the system, in machines which, due to their location, can make use of natural or artificial light hitting the machine, the system can also incorporate photovoltaic sensors placed at some point of the machine to recharge the batteries using photovoltaic energy, being especially useful for those machines which are outdoors, outside an establishment, for most of the day; in this case, the invention has a light detection system powered by one of the batteries previously recharged by the photovoltaic sensor which, when it gets dark, connects part of the announcement light system, without the need for dispensing any product and only for the purpose of calling the attention of customers to the machine.

Furthermore, for the case of interactive-type vending machines having a ramp along which the product slides towards the user when the machine has been activated, for example pinball-type machines, the invention incorporates in a plurality of areas of the ramp means for detecting the movement of the product connected to at least one microcontroller. The latter activates, according to a previously established mode, the light means and sound-synthesizing means when said means detect movement of the product. The means for detecting the movement of the product can consist of a plurality of micro-push buttons detecting the movement of the product by impact, or they can be proximity (optical, etc.) sensors for example detecting the movement of the product when it passes through the detection area of the sensor.

A time control chip can furthermore be incorporated to be able to control the triggering of the announcement in a preestablished schedule, making it coincide with the flow of the public crowd whose attention is sought to be attracted and at the same time control the consumption and the autonomy of the system. This is especially useful for the cases in which the system is not powered through photovoltaic sensors, for example in establishments with little light.

### BRIEF DESCRIPTION OF THE DRAWINGS

To better understand of the invention, an embodiment is very briefly described below as an illustrative and non-limiting example thereof. To that end, reference is made to the attached drawings in which:

FIG. 1 shows a basic diagram of the announcement system installed in a non-interactive vending machine.

FIG. 2 shows an elevational view of an interactive-type mechanical vending machine without the upper part where the balls or products to be dispensed are stored

FIG. 3 shows a plan view of an interactive-type mechanical vending machine with the announcement system incorporated, without the upper part where the balls or products to be dispensed are stored

FIG. 4 shows a basic diagram of the announcement system installed in a non-interactive vending machine in which photovoltaic sensors and a light detection system have been incorporated.

### DETAILED DESCRIPTION OF THE INVENTION

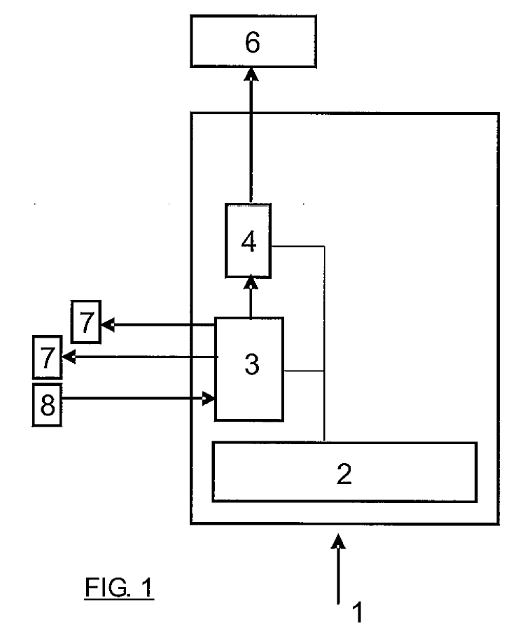

As can be seen in FIG. 1, showing a diagram of the announcement system for mechanical vending machines, the present invention comprises an electronic control board (1) powered by a battery (2). Said control board (1) has a microcontroller (3) with analog and/or or digital inputs and sound-synthesizing means (4) which are responsible for generating the different sound sounds or melodies when commended by the microcontroller (3). These sound-synthesizing means (4) are usually chips specialized in generating or synthesizing music and are connected to the loudspeaker (6) incorporated in the vending machine. The system further comprises a series of light means (7) controlled by the microcontroller (3) which act, together with the sound signals, as an announcement for the users, and means (8) for detecting the rotation of the gear mechanism for activating the machine, which are in turn connected to the microcontroller (3).

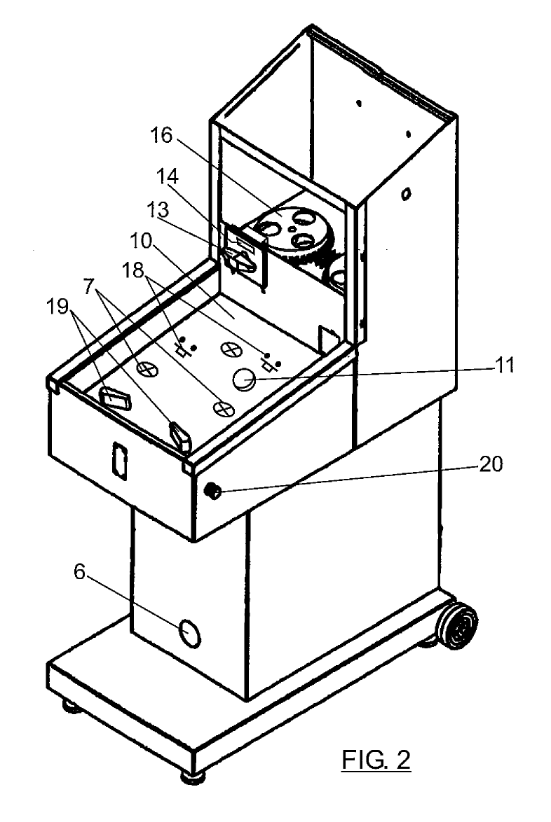

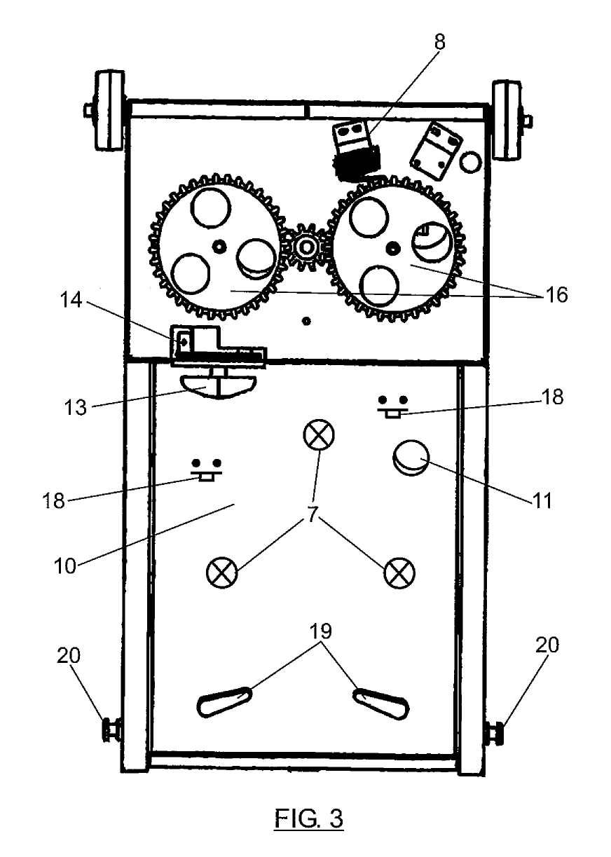

The operation of the system will be explained taking into account FIGS. 2 and 3, which show elevational and plan views, respectively, of an interactive-type mechanical vending machine with the announcement system incorporated, without the upper part where the products to be dispensed are stored so that the operation of the invention can be seen better. However these drawings do not show the electronic control board (1) as it is assembled inside the machine. These types of vending machines have a ramp (10) along which the product (11), for example a ball having a toy inside, falls when the lever (13) for activating the machine is rotated after introducing the correct coin in the coin slot (14). This rotation places in motion the gear mechanism (16) for activating the machine, which starts the machine and allows expending the product (11).

When the means (8) for detecting the rotation of the gear mechanism (16), in this case a micro-push button, detect movement thereof, the microcontroller (3) activates the light means (7), in this case very bright LEDs, and sound-synthesizing means (4) according to a previously established time, usually saved in an EEPROM or flash memory of the microcontroller, which serves to attract the attention of other users.

The system saves the battery if the microcontroller (3) is usually in the minimum consumption state, in sleep mode. The microcontroller (3) only goes to a normal operating state, leaving its minimum consumption state, when it starts up the light and sound systems. In the moment in which the microcontroller (3) disconnects these systems, it will return to the minimum consumption state to thus increase the autonomy of the system object of the invention.

In the embodiment shown in FIGS. 2 and 3, the invention incorporates in the ramp (10) means (18) for detecting the movement of the product, in this case micro-push buttons, which start up the electronic system when they are activated by the hitting of the product which is forcefully thrown by the rotating pivots (19) actuated by both side push-buttons (20). In other words, when these micro-push buttons (18) are activated, which are in turn connected to the inputs of the microcontroller (3), the latter starts up the LEDs (7) and activates the sound-synthesizing means (4) which are heard through the loudspeaker (6) in order to thus make the machine more attractive to the user who is close to the machine at that time. The microcontroller (3) will control, in accordance with what is established in its internal program, the operating time of the light and sound means, the maximum number of hits allowed for each micro-push button (18), the combination of lights, the blinking frequency thereof, the sound games, among other parameters.

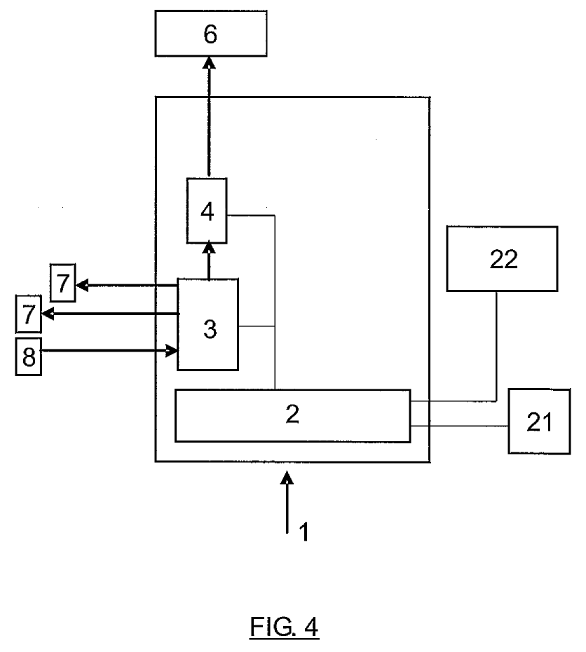

FIG. 4 shows a basic scheme of the announcement system installed in a non-interactive vending machine in which photovoltaic sensors (21) have been incorporated to recharge the battery (2), and a light detection system (22) powered by the battery (2) which, when it gets dark, connects part of the announcement light system, without the need to dispense any product. Said light detection system (22) can be assembled in the electronic control board (1) or outside of it, as in the case shown in FIG. 4. The light detection system (22) can consist for example of the actual voltage drop of the photovoltaic plate or a light sensor connected to one of the inputs of the microcontroller (3), which will determine, according to the information sent by the sensor, whether or not part of the announcement light system should be activated because it is considered that it is already dark.

The announcement system can also incorporate means for controlling the activation of the light means (7) and sound-synthesizing means (4) in a preestablished schedule to attract the public at certain times of the day and to increase the autonomy of the machine in the event that the latter does not work with photovoltaic sensors.

1. An autonomous announcement system for mechanical vending machines of the type that dispense products when the correct coin is entered into a coin slot and a handle for activating the machine is rotated, which places in motion a gear mechanism for activating the machine, wherein it comprises:
at least one electronic control board powered by at least one battery, each board having at least one microcontroller with analog and/or digital or inputs and outputs and sound synthesizing means;
means for detecting the rotation of the handle for activating the machine connected to at least one of the inputs of the microcontroller;
a plurality of light means controlled by the at least one microcontroller; and
at least one loudspeaker connected to the sound-synthesizing means;
and in that when the means for detecting the rotation of the gear mechanism detect movement thereof, the at least one microcontroller activates the light means and sound-synthesizing means according to a previously established time

2. The announcement system according to claim 1, when the vending machines are of the interactive type and have a ramp along which the product slides towards the user when the machine has been activated, wherein said system incorporates in a plurality of areas of the ramp means for detecting the movement of the product connected to the at least one microcontroller, which activates according to a previously established mode the light means and sound-synthesizing means when said means detect movement of the product.

3. The announcement system according to the means for detecting the movement of the product consist of a plurality claim 1, wherein of micro-push buttons

4. The announcement system according to claim 1, wherein the means for detecting the rotation of the gear mechanism for activating the machine consist of a micro-push button which is activated by the movement of the teeth of the gear mechanism.

5. The announcement system according to claim 1, wherein the light means are high-luminescence LEDs.

6. The announcement system according to claim 1, wherein the at least one microcontroller remains in a minimum consumption mode except during the time in which it activates the light means and sound-synthesizing means.

7. The announcement system according to claim 1, wherein it incorporates photovoltaic sensors to recharge the at least one battery.

8. The announcement system according to claim 7, wherein it has a light detection system powered by the at least one battery which at night connects part of the announcement light system, without the need of dispensing any product

9. The announcement system according to claim 8, wherein the light detection system consists of a light sensor connected to the microcontroller.

10. The announcement system according to claim 1, wherein it incorporates means for controlling the activation of the light means and sound-synthesizing means in a preestablished schedule.
